(19) United States
(12) Patent Application Publication
(10) Pub. No.: US 2026/0304544 A1
(43) Pub. Date: Oct. 1, 2026

(54) METHODS AND SYSTEMS FOR TRANSITIONING A USER EQUIPMENT BETWEEN MAIN RADIO AND LOW POWER RADIO

(71) Applicant: Samsung Electronics Co., Ltd., Gyeonggi-do (KR)

(72) Inventors: Neha SHARMA, Bangalore (IN); Shouvik Guha, Bangalore, IN (US)

(21) Appl. No.: 19/564,941

(22) Filed: Mar. 12, 2026

(30) Foreign Application Priority Data
Mar. 27, 2025 (IN) 202541029173
Jan. 19, 2026 (IN) 202541029173

(51) Int. Cl. H04W 76/27; H04W 36/08; H04W 52/02; H04W 68/02; H04W 76/30

(52) U.S. Cl. CPC H04W 76/27; H04W 36/08; H04W 52/0235; H04W 68/02; H04W 76/30

(57) ABSTRACT

A communication method and system are provided for converging a 5th-Generation (5G) communication system or a 6th-Generation (6G) communication system for supporting higher data rates beyond a 4th-Generation (4G) system. A method in a wireless communication system for transitioning a user equipment (UE) between a main radio (MR) and a low-power radio (LR) including detecting a transition of the UE from a radio resource control (RRC) connected state to one of an RRC Idle state or an RRC inactive state, in response to detecting the transition, determining whether to operate the UE in low power radio frequency (RF) mode based on one or more network parameters, and in response to determining to operate the UE in low power RF mode, transmitting, to the UE, in one of an RRC release message or an RRC suspend message, a configuration information element indicating LR operation and that the UE is to switch from the MR to the LR.

### PRIORITY

The present application is based on and claims priority to Indian Provisional Patent Application No. 202541029173 and Indian Non-Provisional Patent Application No. 202541029173, filed in the Indian Patent Office on Mar. 27, 2025, and Jan. 19, 2026, respectively, the entire content of each of which is incorporated herein by reference.

### BACKGROUND

### 1. Field

The disclosure relates generally to wireless communication systems, and more particularly, to methods and systems for transitioning a user equipment (UE) between main radio (MR) and low-power radio (LR) in a wireless communication system.

### 2. Description of Related Art

Considering the development of mobile communication from generation to generation, the technologies have been developed mainly for services targeting humans, such as voice calls, multimedia services, and data services. Following the commercialization of 5th-generation (5G) communication systems, it is expected that the number of connected devices will exponentially increase and will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. To provide various services by connecting hundreds of billions of devices and things in the 6th-generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bits per second (bps) and a radio latency less than 100 microseconds (μsec), and thus will be 50 times as fast as 5G communication systems and have the 1/10 radio latency thereof.

To realize such a high data rate and an ultra-low latency, it has been considered to implement 6G communication systems in a terahertz (THz) band (for example, 95 GHz to 3 THz bands). It is expected that, due to severer path loss and atmospheric absorption in the terahertz bands than those in millimeter wave (mmWave) bands introduced in 5G, technologies capable of securing the signal transmission distance (that is, coverage) will become more crucial. It is necessary to develop, as major technologies for securing the coverage, multiantenna transmission technologies including radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and large-scale antennas. In addition, there has been ongoing discussion on new technologies for improving the coverage of THz-band signals, such as metamaterial-based lenses and antennas, orbital angular momentum (OAM), and reconfigurable intelligent surface (RIS).

To improve the spectral efficiency and the overall network performances, the following technologies have been developed for 6G communication systems: a full-duplex technology for enabling an uplink (UL) transmission and a downlink (DL) transmission to simultaneously use the same frequency resource at the same time, a network technology for utilizing satellites, high-altitude platform stations (HAPS), and the like in an integrated manner, an improved network structure for supporting mobile nodes B and the like and enabling network operation optimization and automation and the like, an use of artificial intelligence (AI) in wireless communication for improvement of overall network operation by considering AI from the initial phase of developing technologies for 6G and internalizing end-to-end AI support functions, and a next-generation distributed computing technology for overcoming the limit of UE computing ability through reachable super-high-performance communication and computing resources over the network.

It is expected that such research and development of 6G communication systems will bring the next hyper-connected experience to every corner of life. Particularly, it is expected that services such as truly immersive extended reality (XR), high-fidelity mobile hologram, and digital replica could be provided through 6G communication systems.

With advancements towards the next generation of wireless communication systems, sustainability has become vital. With an increasing demand for wireless connectivity, it is crucial to design systems that support sustainable development goals. 6G is expected to play a pivotal role in achieving sustainable development goals by delivering ultra-reliable, low-latency, and high-throughput connectivity while minimizing energy consumption and environmental impact.

In 5G networks, higher-layer protocols are optimized for a single radio link, which offers high throughput but consumes significant energy. This approach may not be ideal for operations or services that require minimal data or are only used for control plane functions. Radio is a core component of wireless devices such as smartphones, wearables, and Internet of things (IoT) devices, enabling connectivity that is essential for rich applications and ensuring satisfactory standby time. High-performance radios that offer faster data rates tend to consume more power, but conventional techniques to reduce radio power consumption often come at the expense of performance. This results in a fundamental trade-off between performance and power efficiency in a single high-performance radio design.

Thus, there is a need in the art for a solution that obviates these shortcomings of the conventional art.

### SUMMARY

An aspect of the disclosure is to provide a method and apparatus that reduce overall power consumption while maintaining satisfactory levels of performance, thereby achieving sustainability goals in 6G wireless communication systems.

An aspect of the disclosure is to provide a method and apparatus for a dual-radio wireless communication system that align with sustainability principles, thereby creating a more energy-efficient and environmentally friendly system.

In accordance with an aspect of the disclosure, a method in a wireless communication system for transitioning a UE between an MR and an LR is disclosed herein. The method includes detecting a transition of the UE from a radio resource control (RRC) connected state to one of an RRC Idle state or an RRC Inactive state. The method further includes, in response to detecting the transition, determining whether to operate the UE in low power RF mode based on one or more network parameters. The method further includes, in response to determining to operate the UE in low power RF mode, transmitting, to the UE, in one of an RRC release message or an RRC suspend message, a configuration information element indicating LR operation. The configuration information element indicates that the UE is to switch from the MR to the LR.

In accordance with an aspect of the disclosure, a method in a wireless communication system for transitioning a UE between an MR and an LR is disclosed herein. The method includes monitoring one or more parameters associated with the UE operating on the MR during a connected mode discontinuous reception (C-DRX). The method further includes determining, based on the monitored one or more parameters, at least one of an expiration of a DRX On Duration timer, an expiration of a DRX inactivity timer, a receipt of a physical layer, and a media access control (MAC) layer signaling message. The method further includes transmitting, to the UE, one of a physical layer or a MAC layer signaling message comprising a configuration information element indicating LR operation in response to the determination. The configuration information element indicates that the UE is to switch from the MR to the LR.

In accordance with an aspect of the disclosure, a method in a wireless communication system for transitioning a UE between an MR and an LR is disclosed herein. The method includes detecting at least one of: a transition of the UE from an RRC connected state to one of an RRC Idle state or an RRC Inactive state; an expiration of a discontinuous reception (DRX) OnDuration timer; an expiration of a DRX inactivity timer; a receipt of a physical layer signaling message; a MAC layer signaling message. The method further includes transmitting, to the UE, a configuration information element indicating LR operation in response to the detection. The configuration information element indicates that the UE is to switch from the MR to the LR.

In accordance with an aspect of the disclosure, a method in a wireless communication system for transitioning a UE between an MR and an LR is disclosed herein. The method includes receiving, from the UE operating on the MR, UE assistance information (UAI) indicating a power saving requirement. The method further includes determining, based on the received UAI, whether to transition the UE from MR to LR. The method further includes transmitting, to the UE, a configuration information element indicating LR operation in response to the determination. The configuration information element indicates that the UE is to switch from the MR to the LR.

In accordance with an aspect of the disclosure, an apparatus for transitioning a UE between an MR and an LR in a wireless communication system is disclosed herein. The apparatus includes at least one processor communicably coupled with a memory. The at least one processor is configured to detect a transition of the UE from an RRC connected state to one of an RRC Idle state or an RRC Inactive state. The at least one processor is further configured to determine whether to operate the UE in low power RF mode based on one or more network parameters in response to detecting the transition. The at least one processor is further configured to transmit, to the UE, in one of an RRC release message or an RRC suspend message, a configuration information element indicating LR operation in response to determining to operate the UE in low power RF mode. The configuration information element indicates that the UE is to switch from the MR to the LR.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a method for a network-initiated MR to an LR switch, according to an embodiment;

FIG. 2 illustrates a method for a UE-initiated switch from an MR RRC connected to an LR RRC idle state, according to an embodiment;

FIG. 3 illustrates another method for a UE-initiated switch from the MR RRC connected to an LR RRC inactive state, according to an embodiment;

FIG. 4 illustrates a method for the UE using the LR in a C-DRX state, according to an embodiment;

FIG. 5 illustrates a method for an RRC-based transition from the MR to the LR, according to an embodiment;

FIG. 6 illustrates a method for layer 1 (L1) (physical layer) signaling based transition from the MR to the LR, according to an embodiment;

FIG. 7 illustrates a method for LR measurement and reporting, according to an embodiment;

FIG. 8 illustrates a method for LR measurement and reporting, according to an embodiment;

FIG. 9 illustrates a DL-MAC control element (CE) protocol data unit (PDU), according to an embodiment;

FIG. 10 illustrates a DL control information (DCI) format, according to an embodiment;

FIG. 11 illustrates an environment diagram for implementing switching between the MR and the LR, according to an embodiment;

FIG. 12 illustrates a method for transitioning a UE between an MR and an LR using various RRC states, according to an embodiment;

FIG. 13 illustrates a method for transitioning a UE between an MR and an LR by monitoring one or more parameters, according to an embodiment;

FIG. 14 illustrates a method for transitioning a UE between an MR and an LR by detecting one or more RRC state/timer/signaling messages, according to an embodiment;

FIG. 15 illustrates a method for transitioning a UE between an MR and an LR using UE UAI, according to an embodiment;

FIG. 16 is a block diagram of a terminal or UE according to an embodiment; and

FIG. 17 is a block diagram of a base station (BS) according to an embodiment.

### DETAILED DESCRIPTION

Hereinafter, embodiments of the disclosure are described with reference to the accompanying drawings. Accordingly, those of ordinary skill in the art will recognize that various changes and modifications of the embodiments described herein can be made without departing from the scope and spirit of the present disclosure. Descriptions of well-known functions and constructions may be omitted for the sake of clarity and conciseness.

Whether a certain feature or element was limited to being used only once, it may still be referred to as “one or more features”, “one or more elements”, “at least one feature” or “at least one element.” Use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to some “embodiments.” It should be understood that an embodiment is a possible implementation of any features and/or elements of the disclosure. Some embodiments have been described for explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one or more embodiments, or may be found in all or no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors in the disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The disclosure relates to a dual-radio wireless communication system, and techniques for handling switching between two radios of the dual-radio wireless communication system.

The disclosure teaches the dual-radio wireless communication system including an MR and an LR. The MR (also, referred to as the “primary radio”) is configured to handle demanding applications requiring high bandwidth and processing capabilities. The LR is configured to manage connections and perform one or more ancillary functions. The one or more ancillary functions include paging notifications, signal measurements, updating system parameters, and exchanging limited quantities of data packets. The architecture, and particularly division between the MR and the LR, allows each component to operate efficiently within corresponding domains, thereby minimizing unnecessary expenditure of resources and leading to substantial reductions in total energy usage across an entire network infrastructure.

Disclosed is a method for handling switching between the MR and the LR to preserve energy consumption. The method includes defining one or more triggering conditions for one or more scenarios. The one or more scenarios include the MR switching to the LR or the LR switching to the MR. The method also includes establishing one or more signaling protocols to facilitate seamless switching between the MR and the LR.

When the MR transitions to the LR mode, the LR is powered on, and the system begins by monitoring a synchronization channel on the LR to acquire network synchronization. If the acquisition is successful, the LR may monitor a paging channel for any network signaling. The MR may suspend all operations to save resources and may be shut down, as the MR is no longer required during an operation of the LR. Alternatively, if the acquisition fails on the LR, the UE may return to the MR, triggering a random access channel (RACH) procedure to inform a network about the failure of the MR-to-LR transition. The network may decide to push the UE to the LR again by one of the methods explained in the disclosure, or let the UE continue in the MR.

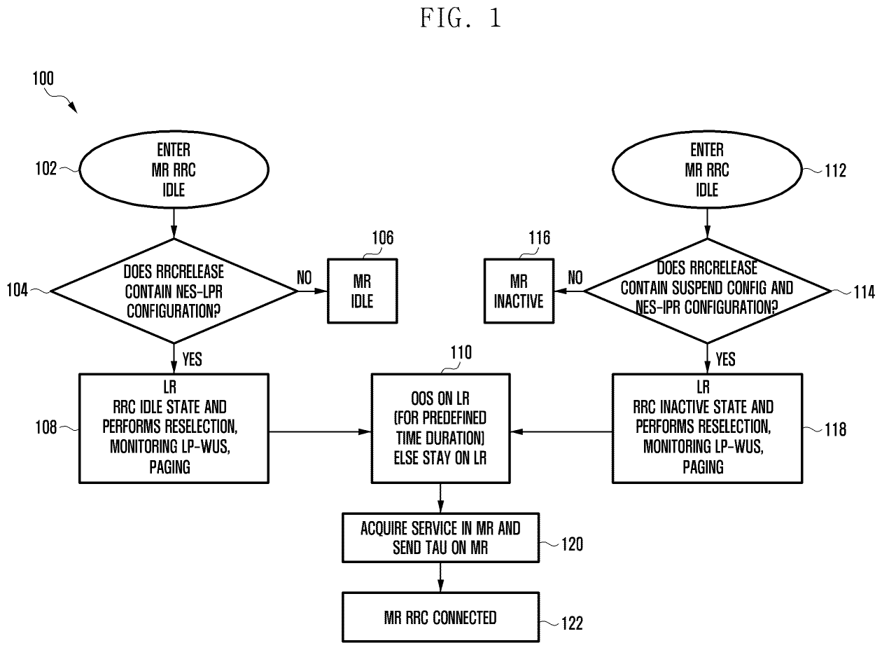

FIG. 1 illustrates a method 100 for a network-initiated MR to LR switch, according to an embodiment. The network may be cellular networks or mobile networks, such as third-generation (3G), fourth-generation (4G), 5G, pre-5G, and 6G networks.

Referring to FIG. 1, in step 102, a UE may enter an MR RRC idle state, in which the UE may not actively maintain an RRC connection with the network. The network may send a command to the UE to operate in low power mode by sending an RRCRelease message.

In step 104, the UE may determine whether the RRCRelease message includes nes-lprConfiguration. The nes-lprConfiguration may refer to an indication for the UE to know that the network is requesting to enable energy saving feature. The nes-lprConfiguration may include low power-wakeup signal (LP-WUS) information, including, but not limited to, waveforms, modulation schemes, and energy efficiency information.

In response to determining that the RRCRelease message does not include the nes-lprConfiguration, the method 100 may proceed to step 106, in which the UE may enter an MR idle state. Alternatively, in step 108, the UE may enter an LR RRC idle state and perform functions such as idle reselection, monitoring LP-WUS information, and paging monitoring. Thereafter, in step 110, the UE may go out-of-service (OOS) while operating on the LR. The UE may go OOS for a predefined time duration, or the UE may stay on the LR.

Alternatively, in step 112, the UE may enter an MR RRC inactive state, in which the UE may not actively transmit or receive data but maintains the RRC connection with the network.

In step 114, the UE may determine whether the RRCRelease message includes a suspend configuration and nes-lprConfiguration.

In response to determining that the RRCRelease message does not include the suspend configuration and the nes-lprConfiguration, the method 100 may proceed to step 116, in which the UE may enter an MR inactive state. Alternatively, the method may proceed to step 118, in which the UE may enter an LR RRC inactive state and perform functions such as reselection, monitoring LP-WUS information, and paging notifications. In step 110, the UE may go OOS while operating on the LR.

In step 120, the UE may acquire service in the MR and send tracking area updates (TAU) or any other signaling message to register back on the MR. In step 122, the UE enters the RRC connected state on the MR.

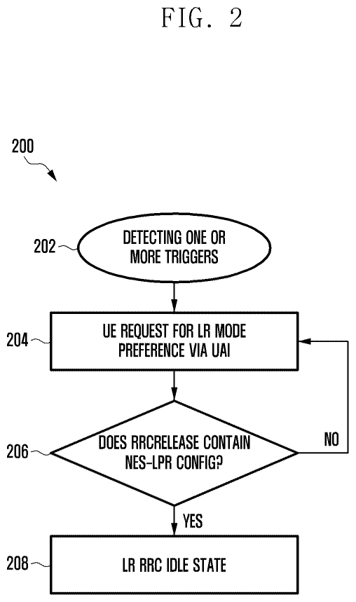

FIG. 2 illustrates a method 200 for a UE-initiated switch from an MR RRC connected to an LR RRC idle state, according to an embodiment.

Referring to FIG. 2, in step 202, the UE may detect one or more triggers for entering a power save mode. The one or more triggers may include, but are not limited to, the UE detecting no data traffic or dormancy for a certain period, a user selecting the power save mode, the UE's battery falling below a predefined threshold battery level, the UE detecting high temperature while operating in the MR state, and the UE and the network negotiating to use the LR instead of the MR.

In response to detecting the one or more triggers, in step 204, the UE may request LR mode preference via a UAI or similar L3 messaging. In step 206, the UE may determine whether the RRCRelease message includes the nes-lprConfiguration. In response to determining that the RRCRelease message does not include the nes-lprConfiguration, the method 200 returns to step 204. Otherwise, in step 208, the UE may enter the LR RRC idle state.

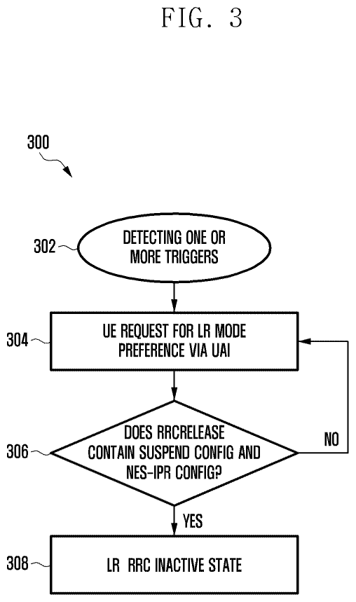

FIG. 3 illustrates another method 300 for a UE-initiated switch from the MR RRC connected to an LR RRC inactive state, according to an embodiment.

Referring to FIG. 3, in step 302, the UE may detect the one or more triggers for entering a power save mode. In response to detecting the one or more triggers, in step 304, the UE may request for LR mode preference via the UAI. In step 306, the UE may determine whether the RRCRelease message includes the suspend configuration along with nes-lprConfiguration. In response to determining that the RRCRelease message does not include nes-lprConfiguration along with the suspend configuration, the method 300 returns to step 304. Otherwise, in step 308, the UE may enter the LR RRC inactive state.

A transition from the MR to the LR may be network-UE coordinated. In another embodiment, a transition from the MR to the LR may be uncoordinated, such as in legacy C-DRX states.

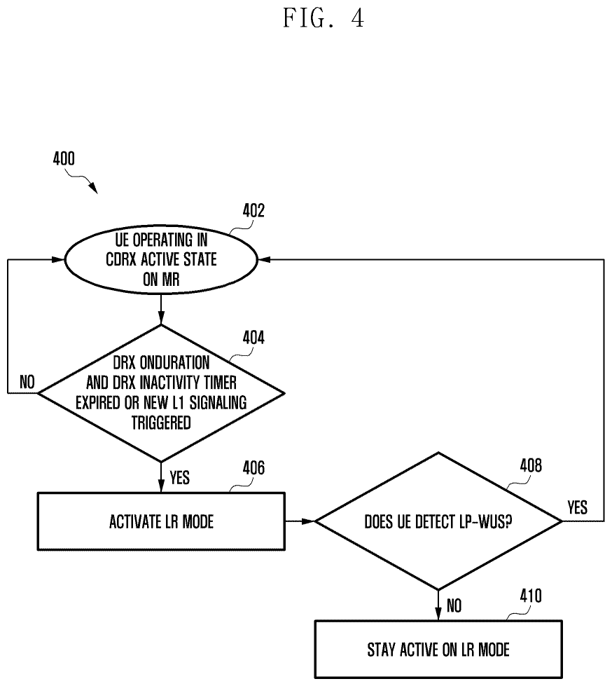

FIG. 4 illustrates a method 400 for a UE using an LR in a C-DRX state, according to an embodiment.

Referring to FIG. 4, in step 402, the UE may be operating in the C-DRX active state on the MR. In step 404, the UE may determine whether the UE is entering into a DRX sleep state. Particularly, the UE may detect whether a DRX on duration and a DRX inactivity timer are expired or a new L1 signaling is triggered. The new L1 signaling may be implemented via one of DCI based (Activate LR) or MAC CE based (Activate LR). In response to determining that the UE is entering into the DRX sleep state, the method 400 proceeds to step 406, in which the UE may activate an LR mode. Otherwise, the method 400 returns to step 402.

Upon activating the LR mode, in step 408, the UE may determine whether the LP-WUS information is detected. The LP-WUS information may include a new waveform (such as an on-off keying (OOK) and the DCI) sent by the network to request the UE to wakeup while operating in the LR mode. In response to detecting the LP-WUS information, the method 400 returns to step 402. Otherwise, the method 400 proceeds to step 410, in which the UE may stay active in the LR mode.

The network may send a command to the UE to operate in the low power mode by sending the RRCRelease message. The RRCRelease message may include low power information, such as, but not limited to, a frequency band, an absolute RF channel number (ARFCN), a physical cell identity (PCI), and a synchronization signal block (SSB).

The nes-lprConfiguration may be added to the RRCReconfiguration message. The nes-lprConfiguration may include the low power information, such as, but not limited to, the frequency band, the ARFCN, the PCI, and the SSB. If the network decides to switch the UE to the LR mode, the network may send DCI to the UE. The DCI may include an indicator to activate an LR mode. For this, the network may select one of one or more pre-configured nes-lprConfiguration options.

In an embodiment, if the MR and the LR are operating in the same frequency band, the network may push the nes-lprConfiguration blindly.

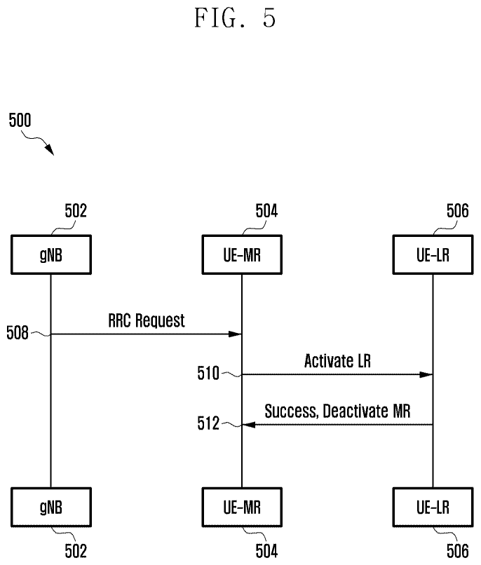

FIG. 5 illustrates a method 500 for an RRC-based transition from the MR to the LR, according to an embodiment. The sequence of operations may be performed between a gNodeB (gNB) 502, a UE-MR 504, and a UR-LR 506. The UE-MR 504 and the UE-LR 506 may indicate a dual-radio in a single UE. The RRC-based transition may be based on using an existing RRC message, as explained in conjunction with FIGS. 3-4, or introducing a new RRC message.

Referring to FIG. 5, in step 508, the gNB 502 may send an RRC Request (e.g., an existing signaling message or new signaling message) to the UE-MR 504 to initiate the transition process. In step 510, in response to the RRC Request, the UE-MR 504 may send a request to the UE-LR 506 to activate the LR mode. In step 512, the UE-LR 506 may send a request to the UE-MR 504 for deactivating the MR mode in response to successful activation of the LR mode.

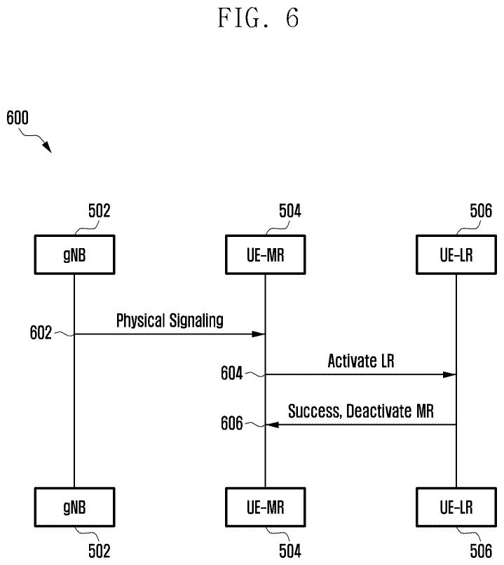

FIG. 6 illustrates a method 600 for the L1 (physical layer) signaling based transition from the MR to the LR, according to an embodiment. The sequence of operations may be performed between a gNodeB (gNB) 502, a UE-MR 504, and a UR-LR 506. The UE-MR 504 and the UE-LR 506 may indicate the dual-radio in a single UE.

Referring to FIG. 6, in step 602, the gNB 502 may send a physical layer signaling, such as DCI or MAC CE, to the UE-MR 504 to initiate the transition process. The DCI or MAC CE may include the indicator to activate the LR mode. In step 604, in response to the RRC Request, the UE-MR 504 may send a request to the UE-LR 506 for activating the LR mode. In step 606, the UE-LR 506 may send a request to the UE-MR 504 for deactivating the MR mode in response to successful activation of the LR mode.

Alternatively, if the MR and the LR are operating in different frequency bands, the network may first configure one of Layer-3 (L3), Layer-1/Layer-2 Triggered Mobility (LTM), or conditional handover (CHO) measurement for the LR.

If the LR uses a different waveform than the MR, the network may include a measurement configuration specifically for the LR in the RRCReconfiguration message. The measurement configuration may be included in a dedicated RRCReconfiguration message for the MR. Additionally, a parameter may be added in the RRCReconfiguration message to enable measurements of the LR.

The measurements of the LR may be sent over one of signaling radio bearer 1 (SRB1) or encapsulated SRBx on the MR. The SRBx may correspond to a new SRB introduced to carry the RRC message sent by the LR.

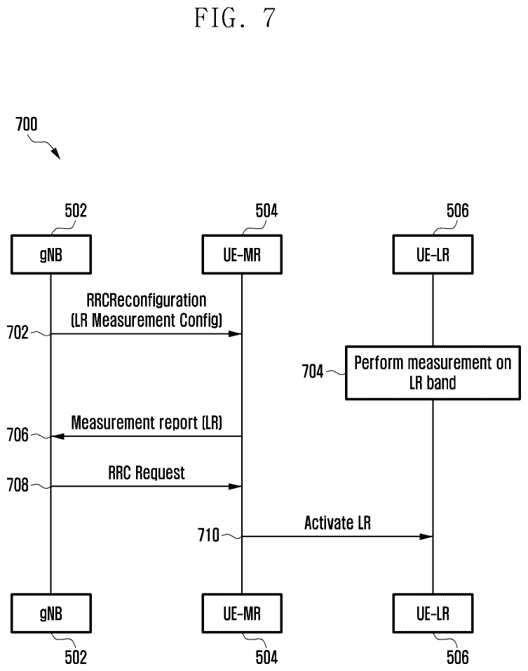

FIG. 7 illustrates a method 700 for LR measurement and reporting, according to an embodiment. The sequence of operations may be performed between a gNodeB (gNB) 502, a UE-MR 504, and a UR-LR 506. The UE-MR 504 and the UE-LR 506 may indicate the dual-radio in a single UE.

Referring to FIG. 7, in step 702, the gNB 502 may send the RRCReconfiguration message to the UE-MR 504. The RRCReconfiguration message may include the measurement configuration related to LR system (which could be same as MR system or different). In step 704, the UE-LR 506 may perform measurements on the LR band. In step 706, the UE-MR 504 may send a measurement report to the gNB 502. The measurement report may correspond to the LR. In step 708, the gNB 502 may send the RRC Request to the UE-MR 504 to initiate the transition process. Thereafter, in step 710, the UE-MR 504 may send a request to the UE-LR 506 to activate the LR mode.

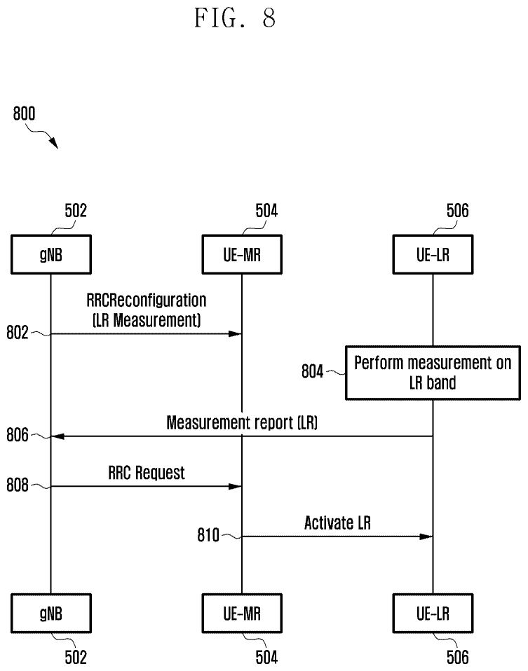

FIG. 8 illustrates a method 800 for LR measurement and reporting, according to an embodiment. The sequence of operations may be performed between a gNodeB (gNB) 502, a UE-MR 504, and a UR-LR 506. The UE-MR 504 and the UE-LR 506 may indicate the dual-radio in a single UE.

Referring to FIG. 8, in step 802, the gNB 502 may send the RRCReconfiguration message to the UE-MR 504. The RRCReconfiguration message may include the measurement configuration related to the LR system. In step 804, the UE-LR 506 may perform measurements on the LR band. In step 806, the UE-LR 506 may send a measurement report to the gNB 502. The measurement report may correspond to the LR. In step 808, the gNB 502 may send the RRC Request to the UE-MR 504 to initiate the transition process. Thereafter, in step 810, the UE-MR 504 may send a request to the UE-LR 506 to activate the LR mode.

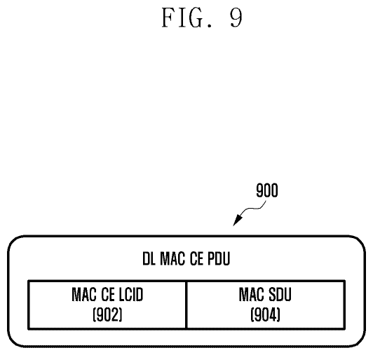

FIG. 9 illustrates a DL MAC CE Protocol Data Unit (PDU) 900, according to an embodiment. Referring to FIG. 9, the DL MAC CE PDU may include a MAC CE logical channel identity (LCID) 902 and MAC service data unit (SDU) 904. The MAC CE LCID 902 may be used to specify which logical channel is carrying control data (i.e., RRC message), and the MAC SDU 904 may be payload of the MAC layer, which can contain user data or higher-layer protocol data. The MAC SDU 904 may include 8 bits, with 1 bit used for the “Activate LR” message and remaining seven bits reserved.

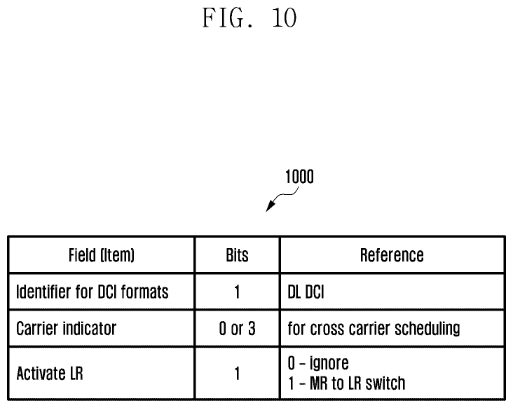

FIG. 10 illustrates a DCI format 1000, according to an embodiment. Referring to FIG. 10, the DCI format 1000 may either reuse an existing DCI format or a new format may be introduced. The DCI format 1000 may include 1 bit for the “Activate LR” message, and 7 bits may be reserved. In the DCI format 1000, 1 bit may be used for a DCI format identifier (for example, a DL DCI), 0 or 3 bits may be used as carrier indicator (i.e., for cross carrier scheduling), and 1 bit may be used for the “Activate LR” message. When the value of Activate LR bit is 0, the request may be ignored, however, when the value of the Activate LR bit is 1, the MR to LR switch may be initiated.

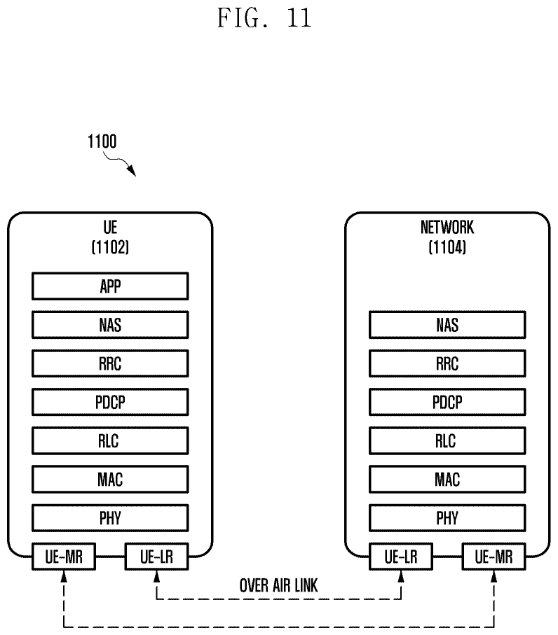

FIG. 11 illustrates an environment diagram 1100 for implementing switching between the MR and the LR, according to an embodiment. Referring to FIG. 11, the environment 1100 may include a UE 1102 and a network 1104. The UE 1102 may correspond to the single UE which includes the UE-MR 504 and the UE-LR 506, and the network 1104 may correspond to the gNB 502.

The UE 1102 may include multiple protocol layers, such as an application (APP) layer, a non-access stratum (NAS) layer, an RRC layer, a packet data convergence protocol (PDCP) layer, a radio link control (RLC) layer, a MAC layer, and the physical (PHY) layer. The UE 1102 may also include the dual-radio-the MR (i.e., the UE-MR 504) and the LR (i.e., the UR-LR 506). The network 1104 may include the NAS layer, the RRC layer, the PDCP layer, the RLC layer, the MAC layer, the PHY layer, the MR and the LR. The MR and the LR of the UE 1102 may be in communication with the MR and the LR of the network 1104, respectively, over an air link.

The APP layer of the UE 1102 may decide to enter the LR mode operation based on various factors including, but not limited to, inputs from one or more sensors available in the UE 1102, such as a sensor to determine a UE's battery level, temperature level, an AI-based detection according to user's usage. Alternatively, one of the RRC layer, the NAS layer, the MAC layer, or the PHY layer may also decide to switch between the MR to the LR operation based on network signaling.

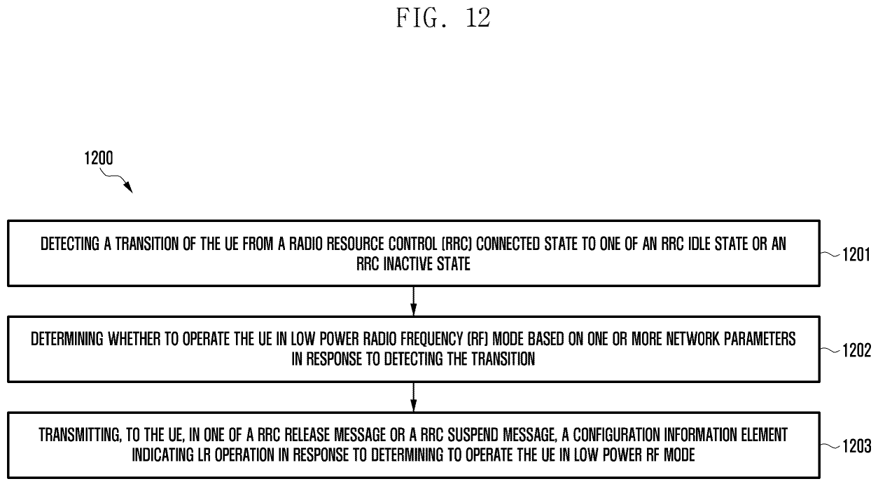

FIG. 12 illustrates a method 1200 for transitioning a UE between an MR and an LR using various RRC states, according to an embodiment as disclosed herein. The method 1200 may execute multiple operations for the transition, which are given below.

Referring to FIG. 12, in step 1201, the method 1200 includes detecting a transition of the UE from an RRC connected state to one of an RRC Idle state or an RRC Inactive state. This detection is achieved by continuously monitoring parameters indicative of UE activity and network signaling while the UE is in the RRC connected state. Such parameters may include the absence of user-plane data traffic for a predefined duration, expiration of DRX-related timers (such as OnDuration or inactivity timers), or receipt of signaling messages that suggest a state change. The monitoring ensures that the transition is identified promptly when the UE moves from an active communication phase to a lower activity phase, enabling the network to initiate energy-saving procedures such as switching the UE from the MR to the LR. This proactive detection mechanism prevents synchronization conflicts between the UE and the network and supports seamless operation in dual-radio architectures designed for power efficiency.

In step 1202, the method 1200 includes determining whether to operate the UE in low power RF mode based on one or more network parameters in response to detecting the transition. The term “network parameters” may include parameters that directly or indirectly influence network-side energy consumption. Such parameters may include, but are not limited to, network data load, which represents the aggregate traffic being processed by the network at a given time and may influence whether the network should push certain UEs to the LR to reduce MR processing overhead. Additionally, the network parameters may include a current consumption threshold associated with network hardware components, such as radio units or baseband processing modules. When the measured or predicted current consumption crosses a predefined threshold, the network may proactively transition eligible UEs from the MR to the LR to prevent energy spikes and maintain overall power efficiency. More generally, any parameter that reflects network resource usage, thermal constraints, power budgeting, or UE-specific load contribution may be considered while determining whether to operate the UE in the low-power RF mode. This determination is performed by evaluating conditions that reflect network capability and operational context, such as whether the network supports low-power radio operation at the given time, the availability of LR resources, and the UE's capability to operate on LR as indicated during prior configuration or through UE UAI. The network may also consider factors like current load conditions, energy-saving policies, and service continuity requirements before deciding to push the UE into LR mode. This decision ensures that the transition aligns with both network optimization goals and UE power-saving requirements, thereby enabling synchronized switching between MR and LR without compromising connectivity or triggering paging conflicts.

In step 1203, the method 1200 includes transmitting, to the UE, in one of a RRC release message or a RRC suspend message, a configuration information element indicating LR operation in response to determining to operate the UE in low power RF mode. In response to transmitting the configuration information element indicating the LR operation, the method 1200 includes performing at least one of: cell re-selection for the UE based on the LR, monitoring one or more paging signaling associated with the UE, and detection of an LP-WUS. In one or more embodiments, after transmitting the configuration information element, the method 1200 enables the UE to perform LR-specific functions, including cell reselection based on LR parameters, monitoring paging signaling over LR, and detecting an LP-WUS for service continuity. These actions ensure that the UE remains synchronized with the network during low-power operation and can promptly transition back to MR upon detecting LP-WUS or an OOS condition, thereby preventing paging misses and maintaining seamless connectivity in a dual-radio architecture.

In response to the detection of the LP-WUS, the method 1200 includes transmitting, to the UE, an updated configuration information element indicating MR operation.

In response to transmitting the configuration information element indicating the LR operation, the method 1200 includes determining an OOS condition for a predefined duration for a service associated with the UE while the UE is operating on the LR. The method 1200 further includes acquiring the service using the MR in response to determining the OOS condition. The method 1200 further includes transmitting, to the UE, an updated configuration information element indicating MR operation.

In response to transmitting the configuration information element indicating the LR operation, the method 1200 includes transmitting, to the UE, a nes-lprConfig message as a part of a Layer 3 RRC Release message comprising suspendConfig and nes-lprConfiguration fields.

The configuration information element indicates the UE to switch from the MR to the LR. The configuration information element corresponds to a nes-IprConfiguration.

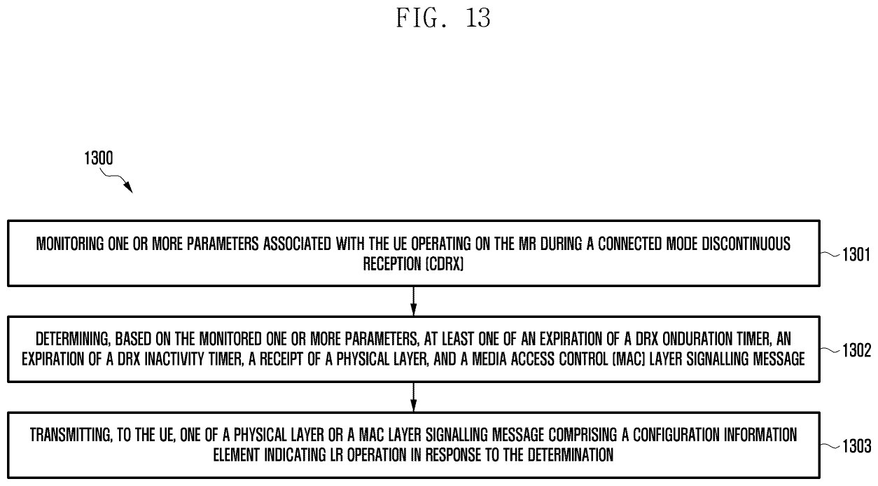

FIG. 13 illustrates a method 1300 for transitioning the UE between the MR and the LR by monitoring one or more parameters, according to an embodiment.

Referring to FIG. 13, in step 1301, the method 1300 includes monitoring one or more parameters associated with the UE operating on the MR during a C-DRX. In step 1302, the method 1300 includes determining, based on the monitored one or more parameters, at least one of an expiration of a DRX OnDuration timer, an expiration of a DRX inactivity timer, a receipt of a physical layer, and a MAC layer signaling message. By leveraging these triggers, the network can initiate a timely and synchronized switch from MR to LR during DRX sleep periods, ensuring low-latency transition and improved energy efficiency without compromising service continuity.

In step 1303, the method 1300 includes transmitting, to the UE, one of a physical layer or a MAC layer signaling message comprising a configuration information element indicating LR operation in response to the determination. In response to transmitting the configuration information element indicating the LR operation, the method 1300 includes monitoring an LP-WUS associated with the UE and transmitting, to the UE, an updated configuration information element indicating MR operation in response to detecting the LP-WUP.

The configuration information element indicates the UE to switch from the MR to the LR and corresponds to a nes-IprConfiguration.

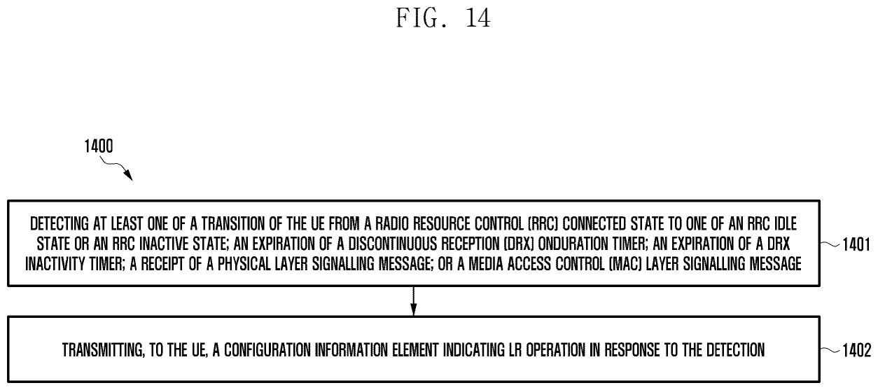

FIG. 14 illustrates a method 1400 for transitioning the UE between the MR and the LR by detecting one or more RRC state/timer/signaling message, according to an embodiment as disclosed herein.

Referring to FIG. 14, in step 1401, the method 1400 includes detecting at least one of: a transition of the UE from an RRC connected state to one of an RRC Idle state or an RRC Inactive state, an expiration of a DRX OnDuration timer, an expiration of a DRX inactivity timer, a receipt of a physical layer signaling message, and a MAC layer signaling message.

To detect the transition of the UE from the RRC connected state to one of the RRC Idle state or the RRC Inactive state, the method 1400 includes monitoring one or more parameters associated with the UE while the UE is operating in the RRC connected state and detecting the transition based on the monitoring.

In step 1402, the method 1400 includes transmitting, to the UE, a configuration information element indicating LR operation in response to the detection. The configuration information element indicates that the UE is to switch from the MR to the LR.

The configuration information element corresponds to a nes-IprConfiguration.

In response to transmitting the configuration information element indicating LR operation, the method 1400 includes performing at least one of: cell re-selection for the UE based on the LR; monitoring one or more paging signaling associated with the UE; and detection of an LP-WUS.

In response to transmitting the configuration information element indicating LR operation, the method 1400 includes determining an OOS condition for a predefined duration for a service associated with the UE while the UE is operating on the LR. The method 1400 further includes acquiring the service using the MR in response to determining the OOS condition. The method 1400 further includes transmitting, to the UE, an updated configuration information element indicating MR operation.

In response to transmitting the configuration information element indicating LR operation, the method 1400 includes transmitting, to the UE, a nes-lprConfig message as part of a Layer 3 RRC Release message comprising suspendConfig and nes-lprConfiguration fields.

In response to transmitting the configuration information element indicating LR operation, the method 1400 includes monitoring an LP-WUS associated with the UE, and in response to detecting the LP-WUS, transmitting, to the UE, an updated configuration information element indicating MR operation.

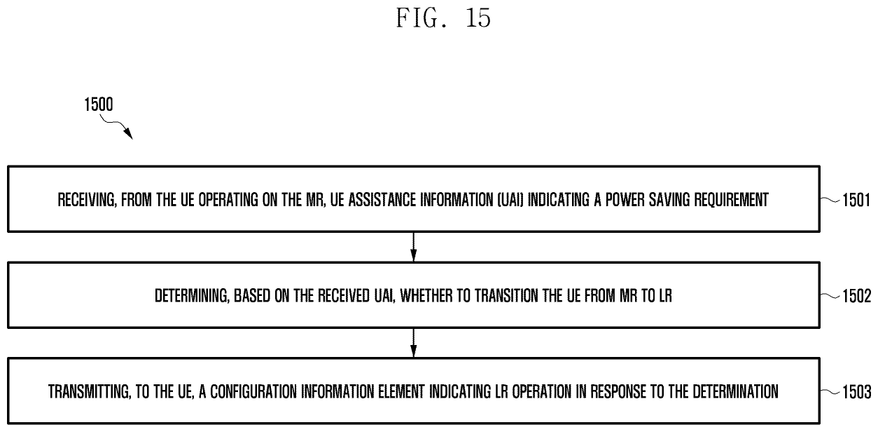

FIG. 15 illustrates a method 1500 for transitioning the UE between the MR and the LR using UAI, according to an embodiment.

Referring to FIG. 15, in step 1501, the method 1500 includes receiving, from the UE operating on the MR, UE assistance information (UAI) indicating a power saving requirement. In step 1502, the method 1500 includes determining, based on the received UAI, whether to transition the UE from MR to LR. In step 1503, the method 1500 includes transmitting, to the UE, a configuration information element indicating LR operation in response to the determination. The configuration information element indicates that the UE is to switch from the MR to the LR.

The configuration information element corresponds to a nes-IprConfiguration.

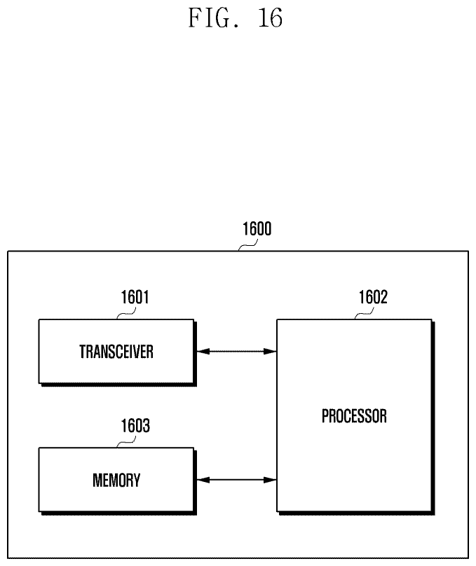

FIG. 16 is a block diagram of a terminal or UE 1600 according to an embodiment.

The terminal is an electronic device capable of wireless communication, may include a UE, a portable phone, a smartphone, a tablet, an device, etc., having various form factors, and may perform wireless communication with a base station (BS) through a wireless channel.

Referring to FIG. 16, the UE 1600 may include at least one transceiver (hereinafter, referred to as simply “transceiver”) 1601, at least one processor (hereinafter, referred to as simply “processor”) 1602, and at least one memory (hereinafter, referred to as simply “memory”) 1603. The transceiver 1601, the processor 1602, and the memory 1603 of the UE 1600 may operate based on at least one or a combination of methods corresponding to the embodiments of the disclosure. However, components of the UE 1600 are not limited to those illustrated in FIG. 16. In another embodiment, the UE 1600 may further include additional components in addition to the above-mentioned components, or some components may be omitted. Any combination of the transceiver 1601, the processor 1602, or the memory 1603 may be integrated in the form of one component.

The transceiver 1601 may be a communication circuit or communication circuitry that enables the UE 1600 to perform wireless communication with a node or an entity of a network. For example, the transceiver 1601 may enable the UE 1600 to transmit or receive a signal to or from a BS through cellular communication, or to transmit or receive a signal to or from another UE through cellular communication. For example, the transceiver 1601 may support at least one of various cellular communication technologies, and various cellular wireless communication technologies supported by the transceiver (1601) may include all subsequent generations of evolved wireless communications.

The UE 1600 may include a plurality of transceivers. For example, in the case of supporting evolved-universal terrestrial radio access-new radio (E-UTRA-NR) dual connectivity (EN-DC), the UE 1600 may include a first transceiver supporting the 4G LTE wireless communication and a second transceiver supporting the 5G NR wireless communication. According to another embodiment, in the case of supporting NR-dual connectivity (NR-DC), the UE 1600 may include a plurality of transceivers supporting the 5G NR wireless communication. According to still another embodiment, in the case of supporting near field wireless communication, the UE 1600 may separately include a transceiver supporting at least one standard in the group of wireless communication protocol standards as defined in the protocol standards for Bluetooth®, wireless local area network (WLAN) network (including institute of electrical and electronics engineers (IEEE) 802.11-2016 standard or its amendments, e.g., 802.11ah, 802.11ad, 802.11ay, 802.11ax, 802.11az, 802.11ba, and 802.11be, without being limited thereto).

The transceiver 1601 may include various circuit structures used to transmit or receive signals to or from a BS through a wireless channel. The signals may include control information and data. For example, the transceiver 1601 may include an RF transmitter for up-converting and amplifying the frequency of a transmitted signal and an RF receiver for low-noise-amplifying a received signal and down-converting the frequency thereof. The transceiver 1601 may output a signal received through a wireless channel to the processor 1602 and may transmit, through a wireless channel, a signal output from the processor 1602.

The processor 1602 may control general operations of the UE 1600 according to embodiments of the disclosure. The processor 1602 may be implemented by one or more integrated circuit (or circuitry) (IC) chips and may execute various data processings. The processor 1602 may include at least one electric circuit, and may execute instructions (or a program, codes, data, etc.) stored in the memory 1603, individually, collectively or in any combination thereof. Further, the processor 1602 may include a single-core processor or multi-core processor, and may include a processor assembly including a plurality of processing circuits (circuitry) according to a specific implementation scheme.

The processor 1602 may be electrically, operatively, or communicatively coupled to the transceiver 1601 to control the transceiver 1601.

The processor 1602 may include at least one processor (or processing circuitry), and the at least one processor may perform the following operations individually, collectively or in any combination thereof. For example, the processor 1602 may include a communication processor (CP) configured to control communication operations and an application processor (AP) configured to control execution of an upper layer (for example, an application layer). In a specific embodiment, at least a part of the processor 1602 may be included in one chip and the other part of the processor 1602 may be included in another chip. Otherwise, at least one processor may be included in another component, for example, the transceiver 1601 or the memory 1603.

The processor 1602 may perform or control or cause an operation of the UE 1600 for executing at least one or a combination of methods according to embodiments of the disclosure. For example, the processor 1602 may control operations of the UE 1600 for processing a DL signal received from a BS or generating and transmitting a UL signal to a BS. To this end, the processor 1602 may execute a computer program, codes, or instructions stored in the memory 1603, so as to control other components of the UE 1600 to enable execution of various operations.

The memory 1603 corresponds to a hardware storage device capable of temporarily or permanently storing information and may include one or more storage media. For example, the memory 1603 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 1603 may be electrically, operatively, or communicatively coupled to the processor 1602 and may be accessed by the processor 1602.

The memory 1603 may store a computer program, codes, or instructions executable by the processor 1602. According to an embodiment, a computer program, codes, or instructions executable by the processor 1602 may be either stored in a single memory device or separated and distributedly stored in two or more memory devices. By executing the instructions stored in the memory 1603, the processor 1602 may perform various functions according to an embodiment.

According to an embodiment of the disclosure, operations of the UE 1600 may be caused to be performed based on execution of instructions (or a computer program or codes) stored in the memory 1603 by at least one processor (or processing circuitry) configured to execute the same individually, collectively, or in any combination thereof, based on processing circuitry that is not configured to execute instructions, and/or based on components of processing circuitry that is not configured to execute instructions.

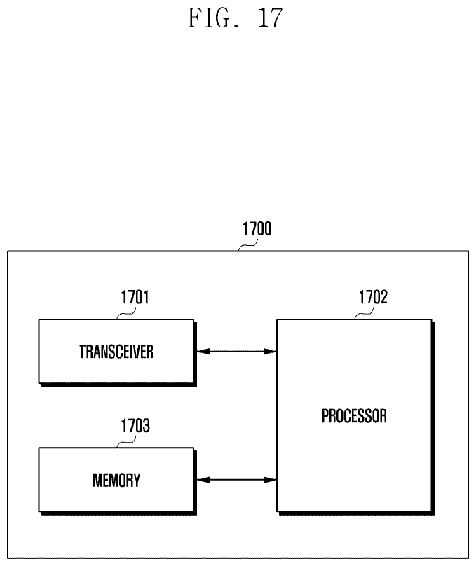

FIG. 17 is a block diagram of a BS 1700 according to an embodiment.

The BS 1700 may perform wireless communication with at least one UE located within the area of the BS 1700 through a wireless channel.

Referring to FIG. 17, the BS 1700 may include at least one transceiver (hereinafter, referred to as simply “transceiver”) 1701, at least one processor (hereinafter, referred to as simply “processor”) 1702, and at least one memory (hereinafter, referred to as simply “memory”) 1703. According to at least one or a combination of methods corresponding to the embodiments described in the disclosure, the transceiver 1701, the processor 1702, and the memory 1703 of the BS 1700 may operate. However, components of the BS 1700 are not limited to those illustrated in FIG. 17. In another embodiment, the BS 1700 may further include additional components in addition to the above-mentioned components, or some components may be omitted. Any combination of the transceiver 1701, the processor 1702, or the memory 1703 may be integrated in the form of one component.

The transceiver 1701 may be a communication circuit or communication circuitry that enables the BS 1700 to perform wireless communication with a node or an entity of a network. For example, the transceiver 1701 may enable the BS 1700 to transmit or receive a signal to or from the UE 1600 through cellular communication, or to transmit or receive a signal to or from another network entity through wireless communication. For example, the transceiver 1701 may support various cellular communication technologies including 3rd generation (3G), 4th generation (4G), long term evolution (LTE), 5th generation (5G) NR, 6th generation (6G), and various cellular wireless communication technologies supported by the transceiver (1701) may include all subsequent generations of evolved wireless communications. The transceiver 1701 may include various circuit structures used to transmit or receive signals to or from a UE through a wireless channel. The signals may include control information and data. For example, the transceiver 1701 may include an RF transmitter for up-converting and amplifying the frequency of a transmitted signal and an RF receiver for low-noise-amplifying a received signal and down-converting the frequency thereof. The transceiver 1701 may output a signal received through a wireless channel to the processor 1702 and may transmit, through a wireless channel, a signal output from the processor 1702.

The BS 1700 may perform communication with a node or an entity of a network through wired or wireless communication. For example, the BS 1700 may perform wired or wireless communication with an adjacent BS, or a node or an entity of a core network through a backhaul network. Although not illustrated in FIG. 17, when the BS 1700 performs wired communication, the BS 1700 may further include a separate network interface for wired communication in addition to the transceiver 1701. The network interface may be referred to as network interface circuitry or communication interface circuitry.

The processor 1702 may control general operations of the BS 1700 according to embodiments of the disclosure. The processor 1702 may be implemented by one or more integrated circuit (or circuitry) (IC) chips and may execute various data processings. The processor 1702 may include at least one electric circuit, and may execute instructions (or a program, codes, data, etc.) stored in the memory 1703, individually, collectively or in any combination thereof. Further, the processor 1702 may include a single-core processor or multi-core processor, and may include a processor assembly including a plurality of processing circuits (circuitry) according to a specific implementation scheme.

The processor 1702 may be electrically, operatively, or communicatively coupled to the transceiver 1701 to control the transceiver 1701.

The processor 1702 may include at least one processor (or processing circuitry), and the at least one processor may perform the following operations individually, collectively or in any combination thereof. In a specific embodiment, at least a part of the processor 1702 may be included in one chip and the other part of the processor 1702 may be included in another chip. Otherwise, at least one processor may be included in another component, for example, the transceiver 1701 or the memory 1703.

The processor 1702 may perform or control or cause an operation of the BS 1700 for executing at least one or a combination of methods according to embodiments of the disclosure. For example, the processor 1702 may control operations of the BS 1700 for generating and transmitting a DL signal to a UE or processing a UL signal received from a UE. Otherwise, the BS 1700 may transmit or receive a signal to or from a neighboring BS, transfer a signal received from a UE to an upper node of the network, or transmit a signal transferred from an upper node of the network to a UE. To this end, the processor 1702 may execute a computer program, codes, or instructions stored in the memory 1703, so as to control other components of the BS 1700 to enable execution of various operations.

The memory 1703 corresponds to a hardware storage device capable of temporarily or permanently storing information and may include one or more storage media. For example, the memory 1703 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 1703 may be electrically, operatively, or communicatively coupled to the processor 1702 and may be accessed by the processor 1702.

The memory 1703 may store a computer program, codes, or instructions executable by the processor 1702. According to an embodiment, a computer program, codes, or instructions executable by the processor 1702 may be either stored in a single memory device or separated and distributedly stored in two or more memory devices. By executing the instructions stored in the memory 1703, the processor 1702 may perform various functions according to an embodiment.

Operations of the BS 1700 may be caused to be performed based on execution of instructions (or a computer program or codes) stored in the memory 1703 by at least one processor (or processing circuitry) configured to execute the same individually, collectively, or in any combination thereof, based on processing circuitry that is not configured to execute instructions, and/or based on components of processing circuitry that is not configured to execute instructions.

The disclosure provides various advantages, such as reducing overall power consumption while maintaining satisfactory levels of performance, thereby achieving sustainability goals in 6G wireless communication systems. Additionally, the disclosed dual-radio wireless communication system aligns with sustainability principles, thereby creating a more energy-efficient and environmentally friendly wireless communication system. Thus, the disclosure not only reduces energy consumption but also optimizes the efficient use of resources, ultimately contributing to a more sustainable wireless communication system.

While the disclosure has been illustrated and described with reference to various embodiments of the present disclosure, those skilled in the art will understand that various changes can be made in form and detail without departing from the spirit and scope of the disclosure as defined by the appended claims and their equivalents.

What is claimed is:

1. A method in a wireless communication system for transitioning a user equipment (UE) between a main radio (MR) and a low-power radio (LR), the method comprising:
detecting a transition of the UE from a radio resource control (RRC) connected state to one of an RRC idle state or an RRC inactive state;
in response to detecting the transition, determining whether to operate the UE in low power radio frequency (RF) mode based on one or more network parameters; and
in response to determining to operate the UE in low power RF mode, transmitting, to the UE, an RRC message including a configuration information element indicating an LR operation;
wherein the RRC message includes one of an RRC release message or an RRC suspend message, and
wherein the configuration information element indicates the UE to switch from the MR to the LR.

2. The method of claim 1, wherein detecting the transition of the UE from the RRC connected state to one of the RRC idle state or the RRC inactive state comprises:
monitoring one or more parameters associated with the UE while UE is operating in the RRC connected state; and
detecting the transition of the UE from the RRC connected state to one of the RRC idle state or the RRC inactive state based on the monitoring.

3. The method of claim 1, wherein the configuration information element includes a nes-IprConfiguration.

4. The method of claim 1, further comprising, in response to a transmission of the configuration information element, performing at least one of:
a cell re-selection for the UE based on the LR;
monitoring one or more paging signaling associated with the UE; and
a detection of low-power wake-up signal (LP-WUS).

5. The method of claim 4, wherein in response to the detection of the LP-WUS, the method further comprises:
transmitting, to the UE, an updated configuration information element indicating MR operation.

6. The method of claim 1, wherein in response to transmitting the configuration information element indicating the LR operation, the method further comprises:
determining an out-of-service (OOS) condition for a predefined duration for a service associated with the UE while the UE is operating on the LR;
in response to determining the OOS condition, acquiring the service using the MR; and
transmitting, to the UE, an updated configuration information element indicating MR operation.

7. The method of claim 1, wherein transmitting the configuration information element indicating LR operation comprises:
transmitting, to the UE, a nes-lprConfig message as a part of a Layer 3 RRC release message comprising suspendConfig and nes-lprConfiguration fields.

8. An apparatus for transitioning a user equipment (UE) between a main radio (MR) and a low-power radio (LR) in a wireless communication system, the apparatus comprising:
a memory; and
at least one processor communicably coupled with the memory, the at least one processor is configured to:
detect a transition of the UE from a radio resource control (RRC) connected state to one of an RRC idle state or an RRC inactive state,
in response to a detection of the transition, determine whether to operate the UE in low power radio frequency (RF) mode based on one or more network parameters, and
in response to a determination to operate the UE in low power RF mode, transmit, to the UE, an RRC message including a configuration information element indicating an LR operation,
wherein the RRC message includes one of an RRC release message or an RRC suspend message, and
wherein the configuration information element indicates the UE to switch from the MR to the LR.

9. The apparatus of claim 8, wherein the at least one processor is further configured to, for detecting the transition of the UE from the RRC connected state to one of the RRC idle state or the RRC inactive state:
monitor one or more parameters associated with the UE while UE is operating in the RRC connected state, and
detect the transition of the UE from the RRC connected state to one of the RRC idle state or the RRC inactive state based on the monitoring.

10. The apparatus of claim 8, wherein the configuration information element includes a nes-IprConfiguration.

11. The apparatus of claim 8, wherein the at least one processor is further configured to perform at least one of:
a cell re-selection for the UE based on the LR;
monitoring one or more paging signaling associated with the UE; and
a detection of low-power wake-up signal (LP-WUS).

12. The apparatus of claim 11, wherein the at least one processor is further configured to transmit, in response to the detection of the LP-WUS, to the UE, an updated configuration information element indicating MR operation.

13. The apparatus of claim 8, wherein, in response to a transmission of the configuration information element indicating the LR operation, the at least one processor is further configured to:
determine an out-of-service (OOS) condition for a predefined duration for a service associated with the UE while the UE is operating on the LR,
in response to determining the OOS condition, acquire the service using the MR, and
transmit, to the UE, an updated configuration information element indicating MR operation.

14. The apparatus of claim 8, wherein a transmission of the configuration information element indicating LR operation includes a transmission of a nes-lprConfig message as a part of a Layer 3 RRC Release message comprising suspendConfig and nes-lprConfiguration fields.
